(19) United States
(12) Patent Application Publication
(10) Pub. No.: US 2010/0062120 A1
(43) Pub. Date: Mar. 11, 2010

(54) ULTRASONIC AGING DEVICE FOR ALCOHOLIC BEVERAGES

(75) Inventors: WOO HWAN JANG, Pusan (KR); CHANG HWAN JANG, Plano, TX (US)

Correspondence Address: CHANG HWAN JANG, 7724 ORLY CT, PLANO, TX, 75044, US

(73) Assignee: Dong Young Engineering, Inc., Gimhae-city (KR)

(21) Appl. No.: 12/204,851

(22) Filed: Sep. 5, 2008

(51) Int. Cl. C12H 1/22

(52) U.S. Cl. 426/234; 99/277.2

(57) ABSTRACT

A device and method uses ultrasonic vibration to modify the molecular structure of water, alcohol, and other additives in a closed container without opening the container and without adding additives. The method comprises applying ultrasonic vibration to a bottle holding an alcoholic beverage to speed up the aging process of the beverage. The ultrasonic vibration is applied at resonant frequency for a length of time sufficient to produce desired aging of the alcoholic beverage. The method further comprises establishing a separation distance between the said vibration delivery plate and the alcoholic beverage. A vibration transfer medium, which may be clean or drinking water, is used to transfer the ultrasonic vibration from the vibration delivery plate to the alcoholic beverage to be aged. The method further comprises determining the said separation distance between the vibration delivery plate and the object to be aged by calculating the distance when the ultrasonic wave reaches the object to be aged is at maximum. Furthermore, the device is portable and can age commercially available alcoholic beverages to desired aging in less than 5 minutes. The alcoholic beverage aged by the present method maintains improved taste and aroma for a long period of time and alleviates severe hangover due to easier digestion.

### BACKGROUND

Alcoholic beverages such as fermented drinks (rice wine, fruit wine, etc.) and distilled drinks (whisky, brandy, etc.) that are aged over several years have improved taste and aroma. However, majority of the inexpensive beverages commercially available have not been through enough fermentation and aging period therefore they tend to exhibit inferior taste and aroma while causing stronger hangovers. One method of aging alcoholic beverages is applying ultrasonic vibration to the un-opened beverages. This method modifies the molecular structure of water, alcohol, and other additives in the drinks within a relatively short amount of time to achieve the desired aging effect.

U.S. Pat. Application US2007/0209520 by Ho et al. discloses a device for aging distilled beverages using ultrasonic vibration unit attached to a bottom of the aging container having a chamber formed by a peripheral wall and applying a frequency to vibrate and heat the liquid in order to oxidize the product. One of the downside of this aging device is that the vibrating device, which is in direct contact with the bottle, may cause noise and damage to the bottles during the aging process. In addition, this aging device is limited in its use due to its size accommodating only liquor or wine bottles. Also, the length of time it takes for the device to achieve the desired aging results, which may range from tens of minutes to hours, may be considered by some to be too long.

The present invention makes it possible to age a variety of commercially available alcoholic beverages in a short amount of time of typically less than 5 minutes, resulting in the same deep taste and aroma that can only be found in drinks that are aged over a long period of time.

### SUMMARY

The present disclosure pertains to aging device for alcoholic beverages including fermented drinks(rice wine, fruit wine, etc), distilled drinks(whisky, brandy, etc), and other cocktail drinks where ultrasonic vibration is used to modify the molecular structure of water, alcohol, and other additives without opening bottles and without adding additives.

In one embodiment, a portable ultrasonic aging device for alcoholic beverages provides means to age commercially available alcoholic beverages in less than 5 minutes without opening and without adding additives. The device comprises a bottom container, a top container, a vibration delivery plate, a piezoelectric device under the said vibration delivery plate, a control circuitry, and a vibration transfer medium. The bottom container is comprised of an opening and a frame at the top and a base support at its bottom to which one or more cleats and bolts are attached. The top container is comprised of an inner frame to fit into the opening frame of the said bottom container and a support frame which holds an object holder plate on which the said beverage to be aged is placed. The vibration delivery plate at the bottom of the top container is made of stainless steel of approximately 1 mm thickness. There is a separation between the vibration delivery plate and the product to be aged to allow space for the vibration transfer medium. The control circuitry is located at the outside of the said bottom container and is comprised of a power supply controller and a timer to drive the piezoelectric device. The vibration transfer medium between the vibration delivery plate and the object to be aged in this device may be clean or drinking water. The top container, bottom container, object holder plate, and the cover may be made of ABS (Acrylonitrile Butadiene Styrene) injection moldings.

In another embodiment, a method comprises applying ultrasonic vibration to a container holding an alcoholic beverage to speed up the aging process of the beverage. There is a separation between the said vibration delivery plate and the alcoholic beverage in the direction normal to the vibration delivery plate allowing space for the vibration transfer medium. A vibration transfer medium is used to transfer the ultrasonic vibration through the distance of the said separation between the vibration delivery plate and the object to be aged. The ultrasonic vibration is applied at resonant frequency for a length of time sufficient to produce desired aging of the alcoholic beverage. The method further comprises determining the said separation distance between the vibration delivery plate and the object to be aged by calculating the distance required for the ultrasonic wave to reach the beverage at maximum. The method further comprises using clean or drinking water as the said vibration transfer medium between the vibration delivery plate and the object to be aged.

Additional and alternative features, advantages, uses and embodiments are set forth in or will be apparent from the following description, drawings, and claims.

### BRIEF DESCRIPTION OF THE DRAWINGS

FIG. 1 provides an inclined view of the ultrasonic aging device employing one embodiment of the present invention.

FIG. 2 provides a front cross sectional view of the ultrasonic aging device employing one embodiment of the present invention.

FIG. 3 provides a side cross sectional view of the ultrasonic aging device employing one embodiment of the present invention.

FIG. 4 provides a plane view of the ultrasonic aging device employing one embodiment of the present invention.

FIG. 5 provides a block diagram of the ultrasonic aging device employing one embodiment of the present invention.

FIG. 6 provides an inclined view of an example usage of the ultrasonic aging device employing one embodiment of the present invention.

FIG. 7 provides a cross sectional view of an example usage of the ultrasonic aging device employing one embodiment of the present invention.

FIG. 8 provides an ultrasonic wave propagation diagram.

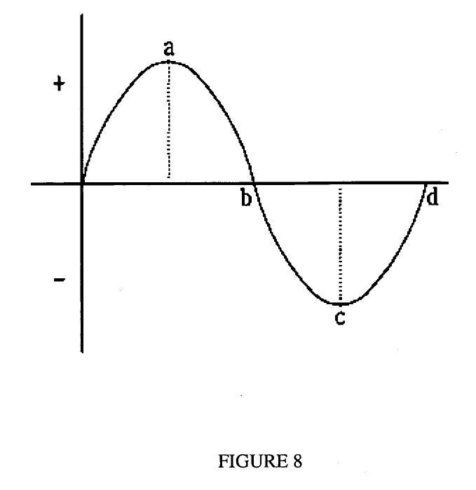

### DESCRIPTION

The present disclosure relates to ultrasonic aging device and method for alcoholic beverages including fermented drinks (rice wine, fruit wine, etc.), distilled drinks (whisky, brandy, etc) and other cocktail drinks where ultrasonic vibration is used to modify the molecular structure of water, alcohol, and other additives without opening the bottles and without adding additives.

For the purposes of promoting an understanding of the principles of the invention, reference will now be made to embodiments or examples illustrated in the drawings, and specific language will be used to describe the same. It will be understood that no limitation of the scope of the invention is thereby intended. Any alteration and further modifications in the described embodiments, and any further applications of the principles of the invention as described herein are contemplated as would normally occur to one skilled in the art to which the disclosure relates.

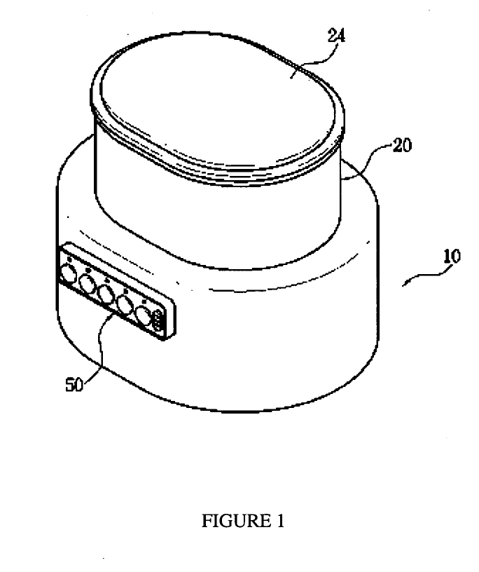

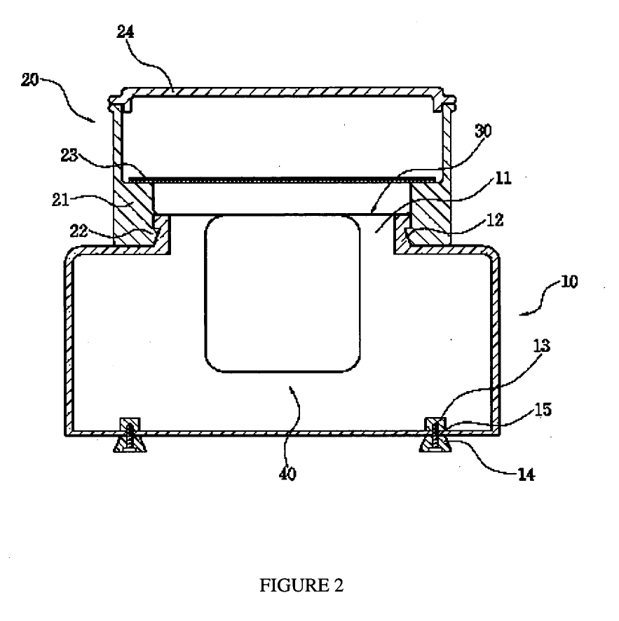

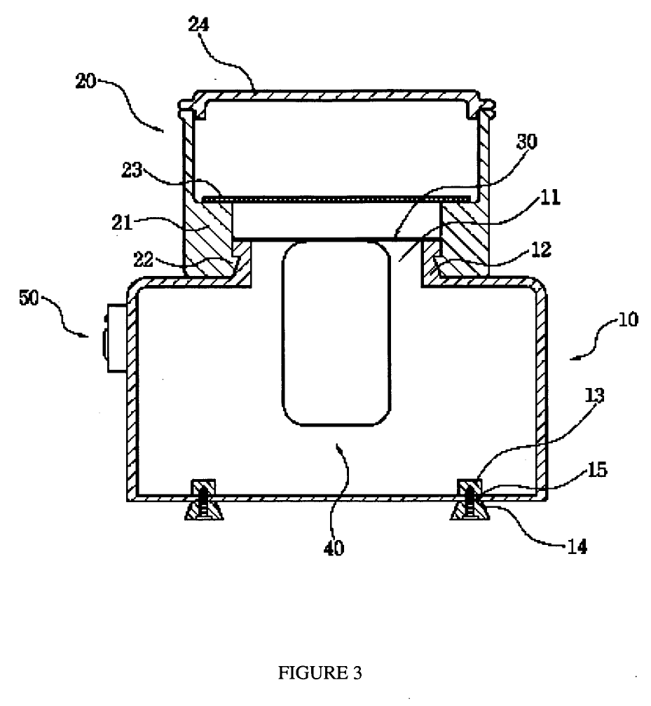

FIG. 1 shows the inclined view of the present invention. FIG. 2 and FIG. 3 are the cross-sectional views of front and side of the present invention, respectfully. The present embodiment comprises a bottom container (10), a top container (20), a vibration delivery plate (30), a piezoelectric device (40), a control circuit (50), and a vibration transfer material (60).

The bottom container (10) consists of an opening (11) with a frame (12) at the top and a base support (14) at the bottom to which a cleat (13) and a bolt (15) is attached to join the base of the bottom container and the base support. The top container (20) consists of the inner frame (22) at the bottom, and a support frame (21) which is to hold an object holder plate (23) on which an object to be aged (70) is placed. The opening frame (12) at the top of the bottom container (10) is used to fit into the inner frame (22) at the bottom of the top container (20). The vibration delivery plate (30) is placed at the bottom of the top container (20) and its objective is to deliver ultrasonic vibrations efficiently and also to position the content of an object to be aged (70) properly. The piezoelectric device (40) is attached under the vibration delivery plate (30) to generate ultrasonic vibrations. The control circuitry (50) consists of a power supply part (51) which controls power supply and a timer (52) that controls and drives the piezoelectric device (40). The control circuit is located at the outer portion of the bottom container (10). The catalyst material (60) is put into the top container (20) from the top and is filled enough to cover the object holder plate (23) where the object to be aged (70) is placed.

The bottom container (10) is comprised of a piezoelectric device (40) which is to drive the vibration delivery plate (30) and a control circuit (50) to set the time for objects to be aged (70). The top container (20) consists of the vibration delivery plate (30) to deliver vibration to objects to be aged (70) and a container to hold a catalyst material (60) to deliver vibration more efficiently to objects to be aged (70).

The bottom container (10) has an opening (11) at the top whose frame (12) is used to join to the top container and a base support (14) at the bottom to which a cleat (13) and a bolt (15) is attached to join the base of the bottom container and the base support. There are four base supports at the bottom of the bottom container.

The top container (20) consisting of the inner frame (22) to fit into the opening frame (12) of the bottom container (10), and a support frame (21) which is to hold an object holder plate (23) on which an object to be aged (70) is placed. The opening frame at the top of the bottom container is used to fit into the inner frame at the bottom of the top container.

The bottom container (10), the top container (20), the object holder plate (23), and the cover (24) are made of ABS (Acrylonitrile Butadiene Styrene) injection moldings.

The vibration delivery plate (30) at the bottom of the top container (20) is to deliver ultrasonic vibrations efficiently and also to position the content of an object to be aged (70) properly. The vibration delivery plate (30) is inserted into the top container (20) to form one body at the injection molding process.

The piezoelectric device (40) generates ultrasonic vibration and is attached under the vibration delivery plate with adhesives and has a maximum output power of 30 W.

The characteristic frequency and the capacitance of a piezoelectric device (40) are determined by material, thickness, and the area of the piezoelectric device. The characteristic frequency of the piezoelectric device used in this invention is 45 KHz.

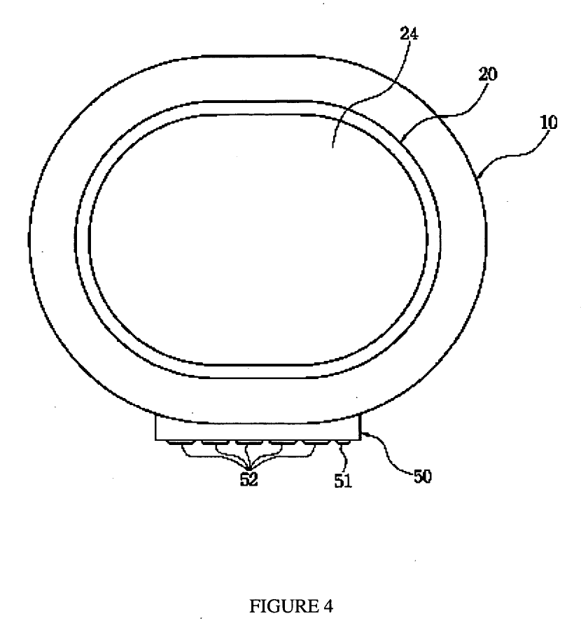

As shown in FIG. 4, the control circuit (50) is located outside of the bottom container (10). The control circuit is comprised of power supply section (51) and timer (52) which controls and drives the piezoelectric device (40). The timer (52) has five switches, 1˜5 min. When any one of the switches is pressed to set the time, the lamp light will be turned on, indicating the ultrasonic aging device is operating.

The catalyst material is put into the top container (20) from the top and is filled enough to cover the object holder plate (23) where the object to be aged (70) is placed.

Clean or drinking water is selectively used as catalyst material (60). The vibration delivery plate (30) is made up of approximately 10 mm thick stainless steel to prevent damage and rust from the catalyst material.

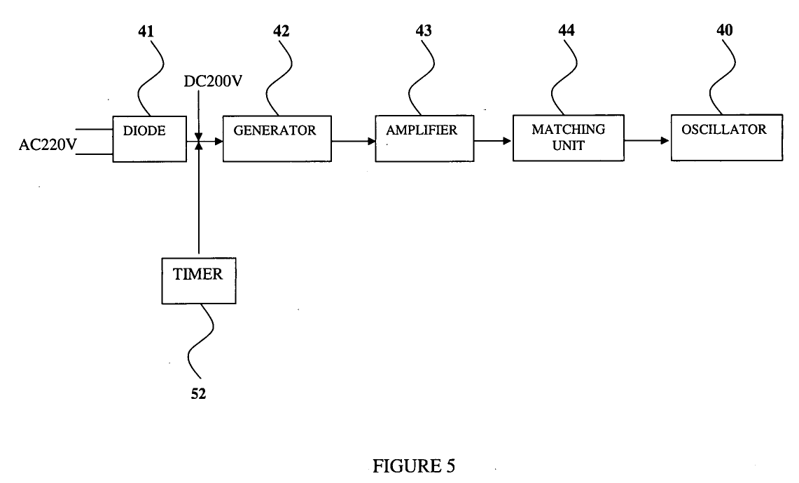

The control circuitry consists of diode, oscillator, amplifier, and matching circuit. As shown in FIG. 5, diode (41) converts 200V AC into 200V DC; Oscillator generates ultrasonic frequency of 45 KHz when a value is selected from the timer (52); Amplifier (43) amplifies a signal whose frequency is 45 KHz to 30 W; matching circuit (44) matches the piezoelectric device (40) to the amplifier.

The resonant frequency is defined as, f₀=1/2π\sqrt{LC}

The value of the reactance, L is varied for the resonant frequency, f₀, to equal the ultrasonic frequency, 45 KHz and the value of the capacitance, C is equal to that of the piezoelectric material.

The object holder plate (23) has a mesh-like structure. The distance between the vibration delivery plate (30) and the object holder plate is determined such that the wavelength of the ultrasonic wave generated by the piezoelectric material (40) should be the largest when it is delivered to the object to be aged.

The distance to the object holder plate (23) from the vibration delivery plate (30) is 17 mm as derived from the equation below. 1540 m is the velocity per second of the ultrasonic wave in clean or drinking water and f₀ in the above equation is equal to the frequency of the ultrasonic wave which is equal to 45 KHz.

Distance=1540 m/2f₀=1540 m/2*45 KHz=17 mm

The distance between the vibration delivery plate (30) and the object holder plate (23) is separated by 17 mm in order for the object to be aged (70) is being aged at the largest wavelength and to avoid the direct contact between the vibration delivery plate (30) and the object to be aged (70).

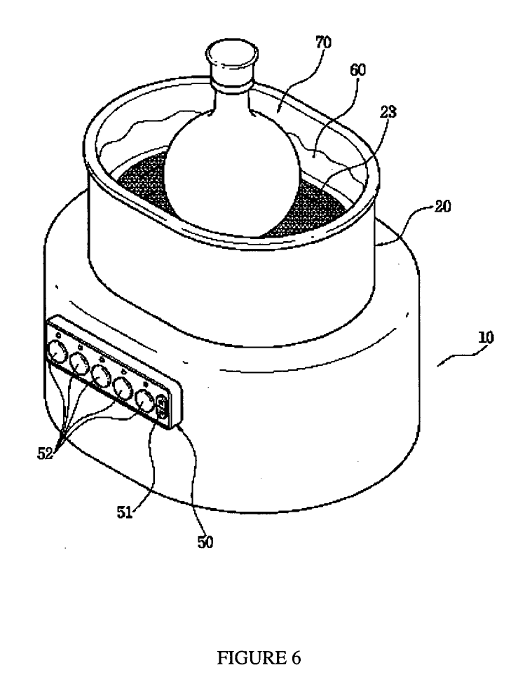

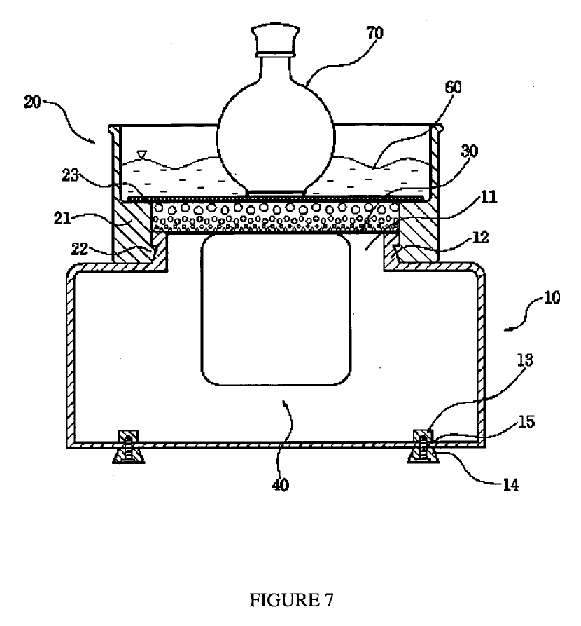

Operating method of the ultrasonic aging device is given below with reference to FIG. 6 and FIG. 7;

Remove the cover (24) from the top container (20). Pour the catalyst material (clean or drinking water) (60) into the top container (20) until it reaches the indicating bar inside the top container. Place the object to be aged (70) on to the object holder plate (23).

Turn on the power (51) on the control circuit (50). Select one of the timer switches (52) 1˜5 min. depending on which one to age, fermented drinks(rice wine, fruit wine, etc), distilled drinks (whisky, brandy, etc), or other cocktail drinks. The ultrasonic aging device will start and the ultrasonic vibrations will reach the object to be aged at high speed, usually a few tens of thousands times per second, rearranging the molecular structures of water, alcohol and other additives present in the object to be aged (70).

Once aged with this device, the improved taste and aroma of the beverage do not change even after the bottle is opened and the state of that aging remains unchanged for a long period of time. This method of aging also allows easier consumption due to smoother taste and alleviates severe hangover because sufficient aging makes alcoholic beverages easier to digest.

It takes approximately 4 minutes to complete the aging process for fermented drinks. For distilled drinks, it takes approximately 3 minutes. For other drinks such as cocktails, 4 minutes should be sufficient.

The present disclosure, therefore, describes a device for providing a means to age commercially available alcoholic beverages to one's own taste in very short time of within 5 minutes without opening and without adding additives,

Although only a few exemplary embodiments have been described in detail above, those skilled in the art will readily appreciate that many modifications are possible in the exemplary embodiments without materially departing from the novel teachings and advantages of this disclosure. Accordingly, all such modifications and alternative are intended to be included within the scope of the invention as defined in the following claims. Those skilled in the art should also realize that such modifications and equivalent constructions or methods do not depart from the spirit and scope of the present disclosure, and that they may make various changes, substitutions, and alterations herein without departing from the spirit and scope of the present disclosure.

What is claimed is:

1. An ultrasonic aging device for alcoholic beverages comprising;
a bottom container with an opening and a frame at the top and a base support at its bottom to which one or more of cleats and bolts are attached,
a top container consisting of an inner frame to fit into the opening frame of the said bottom container and a support frame which holds an object holder plate on which the said beverage to be aged is placed,
a vibration delivery plate at the bottom of the top container,
a piezoelectric device under the said vibration delivery plate,
a control circuitry located at the outside of the said bottom container consisting of a power supply controller and a timer to drive the piezoelectric device, and
a vibration transfer medium between the vibration delivery plate and the object to be aged.

2. The ultrasonic aging device of claim 1, wherein there is a separation between the said vibration delivery plate and the said object holder plate supporting the object to be aged.

3. The ultrasonic aging device of claim 1, wherein the said bottom container is made of injection molded ABS (Acrylonitrile Butadiene Styrene) material.

4. The ultrasonic aging device of claim 1, wherein the said top container is made of injection molded ABS (Acrylonitrile Butadiene Styrene) material.

5. The ultrasonic aging device of claim 1, wherein the said cover is made of injection molded ABS (Acrylonitrile Butadiene Styrene) material.

6. The ultrasonic aging device of claim 1, wherein the said object holder plate is made of injection molded ABS (Acrylonitrile Butadiene Styrene) material.

7. The ultrasonic aging device of claim 1, wherein the said vibration delivery plate, is made of stainless steel of approximately 1.0 mm thickness.

8. The ultrasonic aging device of claim 1, wherein the said control circuitry comprises of a diode; an oscillator which generates ultrasonic vibration of a certain frequency when a corresponding value is selected from the said timer; an amplifier which amplifies the signal to power; and a matching circuit which matches the piezoelectric device to the said amplifier.

9. The ultrasonic aging device of claim 1, wherein the said object holder plate has a mesh-like structure.

10. The ultrasonic aging device of claim 1, wherein the said vibration transfer medium between the vibration delivery plate and the object to be aged is clean or drinking water.

12. A method of ultrasonic aging of alcoholic beverages comprising;
applying ultrasonic vibration to a container holding an alcoholic beverage,
maintaining a separation between the said vibration delivery plate and the object to be aged to avoid direct contact between these components,
using a vibration transfer medium to transfer the ultrasonic vibration through the distance of the said separation between the vibration delivery plate and the object to be aged, and
applying the ultrasonic vibration at resonant frequency for a length of time sufficient to produce desired aging of the alcoholic beverage.

13. A method of ultrasonic aging of alcoholic beverages of claim 12, wherein the said vibration transfer medium between the vibration delivery plate and the object to be aged is clean or drinking water.

14. A method of ultrasonic aging of alcoholic beverages of claim 12, wherein the ultrasonic vibration is controlled by a control circuitry which consists of,
a diode that converts 200V AC into 200V DC;
an oscillator that generates the ultrasonic frequency of 45 KH when a corresponding value is selected from a timer;
an amplifier that amplifies a signal of 45 KHz frequency to 30 W; and
a matching circuit that matches the piezoelectric device to the amplifier.

15. A method of ultrasonic aging of alcoholic beverages of claim 13, wherein the separation distance between the vibration delivery plate and the object holder plate is determined by,
Distance=1540 m/2f₀=1540 m/2*45 KHz=17 mm
such that the wavelength of the ultrasonic wave generated by the piezoelectric material is at maximum at the object to be aged.

16. A method of ultrasonic aging of alcoholic beverages of claim 13, wherein the resonant frequency is defined as,
f₀=1/2π\sqrt{LC}
where value of the reactance L is varied for the resonant frequency to equal the ultrasonic frequency and the value of the capacitance, C is equal to that of the piezoelectric material.
